(19) United States
(12) Patent Application Publication
(10) Pub. No.: US 2011/0309992 A1
(43) Pub. Date: Dec. 22, 2011

(54) NOTCHED ANTENNA ASSEMBLY FOR COMPACT MOBILE DEVICE

(75) Inventor: SHIROOK ALI, WATERLOO (CA)

(73) Assignee: RESEARCH IN MOTION LIMITED, WATERLOO (CA)

(21) Appl. No.: 12/820,843

(22) Filed: Jun. 22, 2010

(30) Foreign Application Priority Data
Jun. 21, 2010 (EP) 10166657.6

(51) Int. Cl. H01Q 1/48; H01Q 5/01

(52) U.S. Cl. 343/848

(57) ABSTRACT

An antenna assembly features a single ground plane with notches spaced apart from each other along edges of the ground plane. The notches are located at a non-coupling distance from an antenna that is positioned at an edge opposite from the notched edges of the ground plane. The notches are configured to extend the electrical length of the ground plane and dimensioned to have a maximum length that eliminates radiation along the individual notches.

The subject application claims Paris Convention priority under 35 U.S.C. 119(a)-(d) to European Patent Application No. 10166657.6 filed on Jun. 21, 2010, the entire content of which is herein incorporated by reference.

### BACKGROUND

1. Technical Field

This disclosure relates to an antenna assembly for a mobile wireless communications device, and more specifically to an antenna assembly that includes a ground plane configured with a plurality of notches that increase the electrical length of the ground plane without inducing radiation within the notched areas.

2. Description of the Related Art

The length of the ground plane or chassis in a wireless communications device affects the antenna operating frequency. In general, an optimum performance of an antenna may be achieved when the physical length of the ground plane is half of a wavelength at the operating frequency or

$$\frac{λ}{2} .$$

For example, within high frequency bands, such as, without limitation, 1.9 Gigahertz (GHz) band, λ would be equal to approximately 15.4 centimeters (cm), which would require that the length of the ground plane be about 7.7 cm for optimum performance. Within low frequency bands, such as, for example, without limitation, 900 Megahertz (MHz), λ would be equal to about 33.4 cm, which would require that the length of the ground plane be about 16.7 cm for optimum performance.

At some frequencies, particularly within the lower frequency band ranges, such as, without limitation, 800 MHz and 900 MHz, achieving the best performance requires that the length of the chassis or ground plane of the wireless device increase beyond a typical mobile phone chassis or ground plane of approximately 10.5 centimeters.

The low frequency bands of the Global System for Mobile Communications (GSM), for example, without limitation, 800 Megahertz (MHz) and 900 MHZ, would require a ground plane of a wireless device to be within the range of approximately 16.7 to 18.8 centimeters.

In order to accommodate or hold the elongated or extended ground planes that may be required in some operating frequency bands, particularly the lower frequency bands, an extension of the length of the chassis or ground plane of the typical mobile wireless device would be required. Such an elongated chassis may not be desirable or acceptable, especially in cases where a compact or small mobile device is desired.

### BRIEF DESCRIPTION OF THE DRAWINGS

For a better understanding of the disclosure and the various embodiments described herein, reference is now made to the following brief description, taken in connection with the accompanying drawings and detailed description, which show at least one exemplary embodiment.

FIG. 1 illustrates a planar isometric view of the notched antenna assembly in a mobile wireless communication device in accordance with an illustrative embodiment of the disclosure;

FIG. 2 illustrates a block diagram of the wireless mobile communications systems according to an illustrative embodiment of the disclosure;

FIG. 3 illustrates a planar view of a notched antenna assembly in accordance with an illustrative embodiment of the disclosure;

FIG. 4A illustrates the current distribution of the notched antenna assembly illustrated in FIG. 3 at a frequency at the 900 MHz band in accordance with an illustrative embodiment of the disclosure;

FIG. 4B illustrates the current distribution of the notched antenna assembly illustrated in FIG. 3 at a frequency at the 1880 MHz band in accordance with an illustrative embodiment of the disclosure;

FIG. 5A illustrates a two-dimensional plot of the radiation pattern of the notched antenna assembly illustrated in FIG. 3 in the phi plane at 900 MHZ band;

FIG. 5B illustrates a two-dimensional plot of the radiation pattern of the notched antenna assembly illustrated in FIG. 3 in the theta plane at 900 MHz band;

FIG. 5C illustrates a two-dimensional plot of the radiation pattern of the notched antenna assembly illustrated in FIG. 3 in the phi plane at 1880 MHZ band;

FIG. 5D illustrates a two-dimensional plot of the radiation pattern of the notched antenna assembly illustrated in FIG. 3 in the theta plane at 1880 MHZ band;

FIG. 6 illustrates a planar view of a notched antenna assembly in accordance with an illustrative embodiment of the disclosure;

FIG. 7A illustrates the current distribution on the ground plane illustrated in FIG. 6 at a frequency at 900 MHz band in accordance with an illustrative embodiment of the disclosure;

FIG. 7B illustrates the current distribution on the ground plane illustrated in FIG. 6 at a frequency at 1880 MHz band in accordance with an illustrative embodiment of the disclosure;

FIG. 8A illustrates a two-dimensional plot of the radiation pattern of the notched antenna assembly illustrated in FIG. 6 in the phi plane at 900 MHZ band;

FIG. 8B illustrates a two-dimensional plot of the radiation pattern of the notched antenna assembly illustrated in FIG. 6 in the theta plane at 900 MHZ band;

FIG. 8C illustrates a two-dimensional plot of the radiation pattern of the notched antenna assembly illustrated in FIG. 6 in the phi plane at 1880 MHZ band;

FIG. 8D illustrates a two-dimensional plot of the radiation pattern of the notched antenna assembly illustrated in FIG. 6 in the theta plane at 1880 MHZ band; and

FIG. 9 illustrates an antenna of the notched antenna assembly of FIG. 1 in accordance with an illustrative embodiment of the disclosure.

### DETAILED DESCRIPTION

It should be understood at the outset that although an illustrative implementation of one or more embodiments are provided below, the description is not to be considered as limiting the scope of the embodiments described herein. The disclosure may be implemented using any number of techniques, whether currently known or in existence. The disclosure should in no way be limited to the illustrative implementations, drawings, and techniques illustrated and described herein, which may be modified within the scope of the appended claims along with a full scope of equivalence. It should be appreciated that for simplicity and clarity of illustration, where considered appropriate, the reference numerals may be repeated among the figures to indicate corresponding or analogous elements.

According to an illustrative embodiment of the disclosure, an antenna assembly for a wireless communications device comprises a single ground plane having a plurality of notches spaced apart at a distance from each other along at least two opposing longitudinal edges of the ground plane. Each notch of the plurality of notches is dimensioned to eliminate radiation from the individual notches. The antenna assembly also comprises a single antenna disposed at an edge of the ground plane that is perpendicular to a first opposing longitudinal edge and a second opposing longitudinal edge of said at least two opposing edges. The plurality of notches are positioned at a distance that prevents radiative coupling with said single antenna.

In accordance with another illustrative embodiment of the disclosure, a mobile communications device comprises a single ground plane having a plurality of notches spaced apart at a distance from each other and disposed along at least two opposing edges of said ground plane, wherein said plurality of notches are individually non-radiating. The mobile communications device includes a single antenna disposed at an edge of said single ground plane that is perpendicular to a first opposing longitudinal edge and a second opposing longitudinal edge of said at least two opposing edges, said single antenna being positioned at a distance that prevents radiative coupling with said plurality of notches. The singular antenna indices current on the singular ground plane.

The present disclosure provides a chassis or ground plane of an antenna assembly in a mobile communications device. The ground plane of the antenna assembly comprises a plurality of notches etched or cut into edges of the ground plane that are opposite to the edge on which the antenna is disposed. The notches control the frequency at which the ground plane resonates and may be dimensioned so that the ground plane resonates concurrently or at approximately the same time as the antenna at a designated frequency.

The best performance of an antenna, as indicated by increased bandwidth and total efficiency, in a mobile communications device may be achieved when both the combination of the chassis or ground plane and the antenna resonate at the same time. Specifically, optimum antenna performance is achieved when the antenna resonant frequency, fₐ, equals the chassis resonant frequency, f_{rc}, or fₐ=f_{rc}. In low frequency bands about or below 1 GHz, such as, but not limited to 900 MHz, the ground plane and the antenna may resonate at the same time as the physical length of the ground plane approaches about 17.0 cm. In high frequency bands about or exceeding 1 GHz, such as, but not limited to 1.9 GHz, the ground plane and the antenna may resonate at the same time as the ground plane approaches a length of approximately 8.0 cm.

The notches increase the electrical length of the ground plane without any corresponding increase in the physical length of the ground plane by forcing the surface currents induced on the ground plane by the antenna to travel a distance that is greater than the linear distance along the perimeter of the ground plane without the notches.

Additionally, the notches are sized to have a trace that is electrically small to prevent each notch from radiating at any frequency and operating as individual antennas. In embodiments of this disclosure, the notches may all be of rectangular dimensions, square dimensions, or a combination of rectangular and square dimensions. The dimensions of the notches prevent the notches from radiating or acting as a source of radiation within the ground plane.

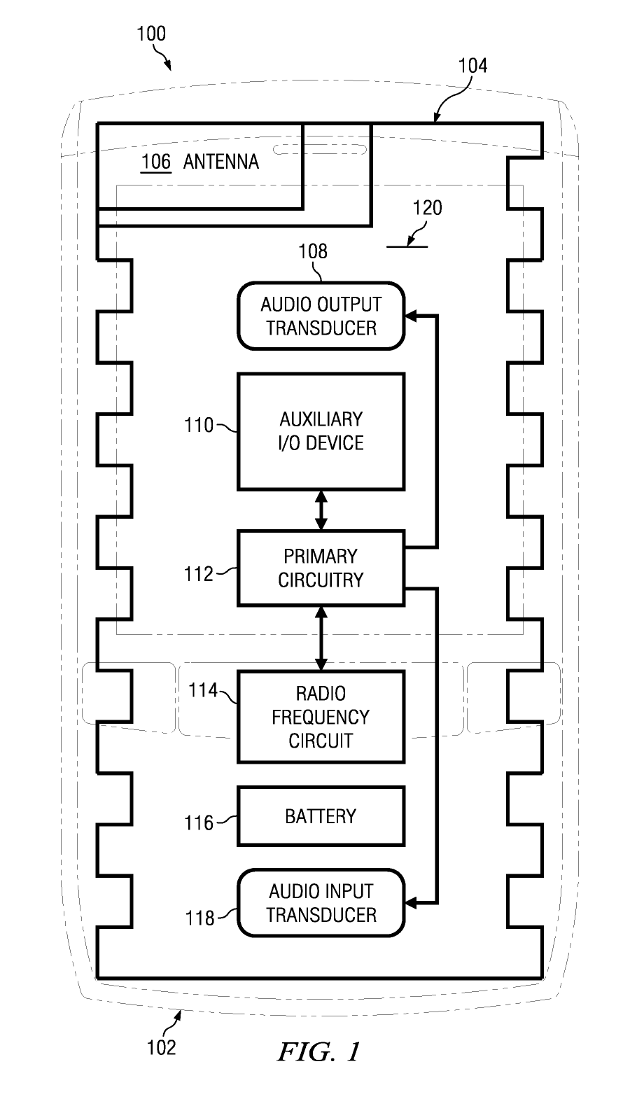

Turning first to FIG. 1, an isometric planar view of an antenna assembly 104 in a mobile communications device 100 is depicted in accordance with an illustrative embodiment of the disclosure. Antenna assembly 104 includes single antenna 106 mounted on a first edge of a single ground plane 120 that is contiguous in shape. Antenna assembly 104 is disposed or located within a housing 102 for mobile communication device 100 or similar mobile terminal.

In the depicted embodiment, a number of components may be mounted anywhere on the entire surface area of either side of ground plane 120. The components may include, without limitation, audio output transducer 108, auxiliary I/O device 110, primary circuitry 112, radio frequency circuitry 114, battery 116, and audio output transducer 118. The components may include passive elements, such as capacitors (not shown), and resistors (not shown), and active elements, such as integrated circuit chips. The components may be mounted to ground plane 120 through vias, traces, pads, and other such mounting techniques recognized by one skilled in the art.

Ground plane 120 of antenna assembly 104 is a single contiguous piece of conductive material. The conductive material may be a metal such as copper or other material known in the art for having good conducting properties. It must be noted that the number of components arranged and illustrated on ground plane 120 is not limited to the number or arrangement of components depicted in antenna assembly 104.

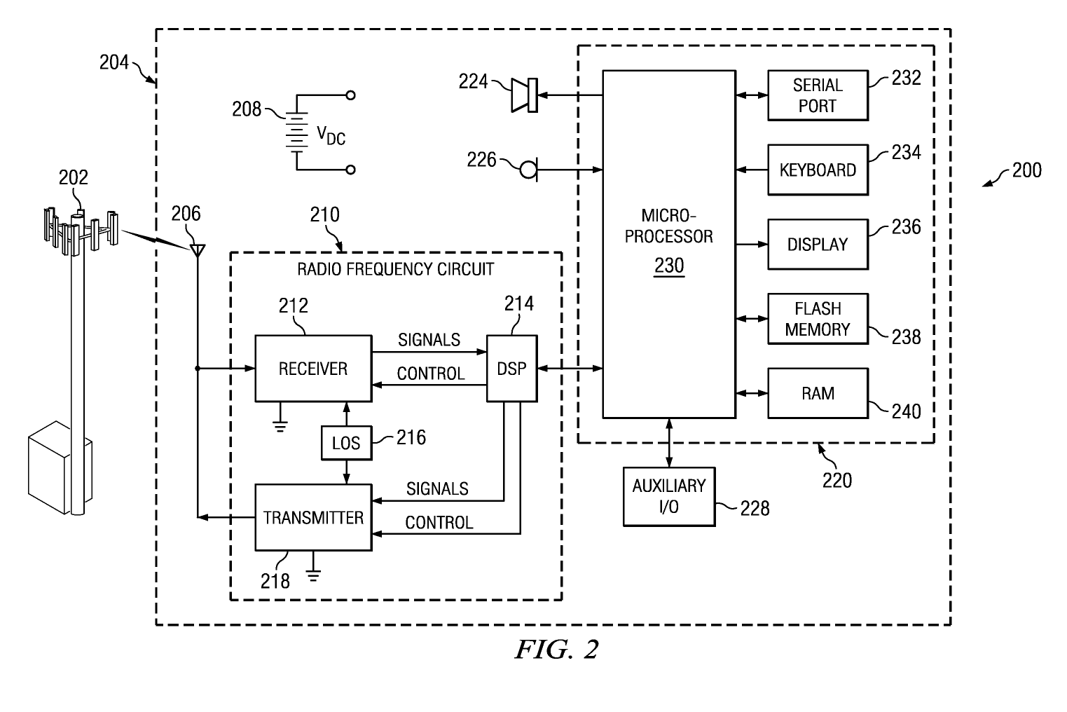

Referring now to FIG. 2, a block diagram of the wireless mobile communications system 200 implementing the notched antenna assembly of FIG. 1 according to an embodiment of the disclosure is illustrated. Wireless mobile communications system 200 depicts an implementation of a mobile communication device, such as mobile communication device 100 of FIG. 1.

In FIG. 2, mobile communication device 204 may be a mobile wireless communication device, such as a mobile cellular device, herein referred to as a mobile device that may function as a Smartphone, which may be configured according to an information technology (IT) policy. Mobile communication device 204 may be configured with a notched antenna assembly, such as notched antenna assembly 104 of FIG. 1.

Examples of applicable communication devices include pagers, mobile cellular phones, cellular smart-phones, wireless organizers, personal digital assistants, computers, laptops, handheld wireless communication devices, wirelessly enabled notebook computers and such other communication devices.

The mobile communication device 204 is a two-way communication device with advanced data communication capabilities including the capability to communicate with other mobile devices, computer systems, and assistants through a network of transceivers. In FIG. 2, the mobile communication device includes a number of components such as microprocessor 230 that control the overall operation of mobile communication device 204.

Communication functions are performed through a radio frequency circuit 210. Radio frequency circuit 210 includes wireless signal receiver 212 and wireless signal transmitter 218 connected to multi-element antenna assembly 206. Radio frequency circuit 210 may also include digital signal processor (DSP) 214 and local oscillators (LOS) 216. The specific design and implementation of radio frequency circuit 210 depends on the communication network in which mobile communication device 204 operates. Mobile communication device 204 receives messages from and sends messages across wireless communications network 202.

Mobile communication device 204 includes battery 208 for supplying power to the internal components. In at least some embodiments, the battery 208 can be a smart battery with an embedded microprocessor. The battery 208 is coupled to a regulator (not shown), which assists the battery 208 in providing power V+ to the mobile communication device 204. Although current technology makes use of a battery, future technologies such as micro fuel cells may provide the power to the mobile communication device 204.

Primary circuitry, such as primary circuitry 112 of FIG. 1, includes microprocessor 230, memory that includes a random access memory (RAM) 240, and a flash memory 238 which provides non-volatile storage. Serial port 232 constitutes a mechanism by which external devices, such as a personal computer, may be connected to mobile communication device 204. Display 236 and keyboard 234 provide a user interface for controlling mobile communication device 204.

Audio input device 226 and audio output device 224 connect to primary circuitry 220 to function as an audio interface. In operation, a received signal such as a text message, an e-mail message, or web page download will be processed by the radio frequency circuit 210 and input to the microprocessor 230. The microprocessor 230 will then process the received signal for output to the display 236 or alternatively to the auxiliary I/O subsystem 228. A subscriber may also compose data items, such as e-mail messages, for example, using the keyboard 234 in conjunction with the display 236 and possibly the auxiliary I/O subsystem 228. The auxiliary I/O subsystem 228 may include devices such as: a touch screen, mouse, track ball, infrared fingerprint detector, or a roller wheel with dynamic button pressing capability. The keyboard 234 is preferably an alphanumeric keyboard together with or without a telephone-type keypad. However, other types of keyboards may also be used.

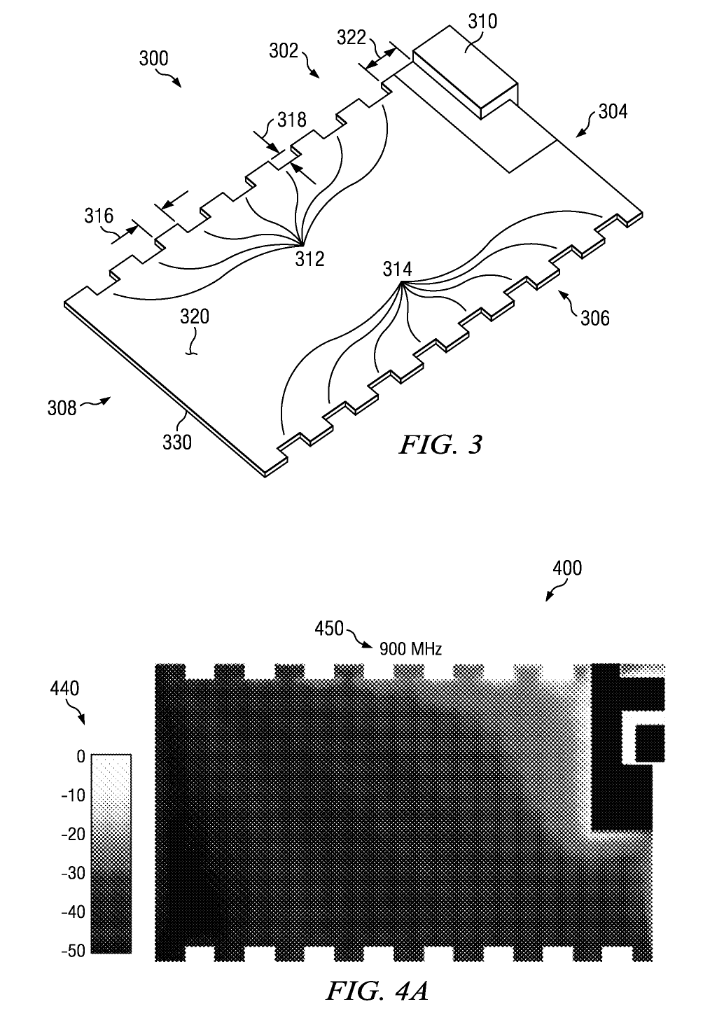

FIG. 3 illustrates a top planar view of antenna assembly 300 in accordance with an illustrative embodiment of the disclosure. In an embodiment, antenna assembly 300 may be antenna assembly 104 as illustrated in FIG. 1.

In FIG. 3, antenna 310 is shown disposed on a first edge 304 of ground plane 320. Ground plane 320 has a plurality of notches 312 extending in a longitudinal direction along a second edge 302 that is opposite to and perpendicular to the plane of antenna 310 and to first edge 304. Third edge 306 has a plurality of notches 314 extending in a longitudinal direction perpendicular to the plane of antenna 310 and opposite first edge 304 and second edge 302. In illustrative embodiments, a fourth edge 308 may also include a number of notches.

Dielectric substrate 330 is disposed on an opposite side of ground plane 320 and may be configured with a pattern of a plurality of notches that is substantially the same as the pattern of plurality of notches, such as plurality of notches 312, 314, in ground plane 320. Dielectric substrate 330 may be formed from a material that includes, but is in no way limited to, air, fiberglass, plastic, and ceramic. Circuit board components may be placed on ground plane 320 or on dielectric substrate 330 through the connection of signal traces to the ground plane 320.

The plurality of notches may approximate the shape of a square waveform having a plurality of pulses that are uniformly disposed along first edge 304 and third edge 306 of ground plane 320 at a distance d 322 from antenna 310. Distance d 322 is the smallest distance required to prevent electromagnetic interaction or radiative coupling between antenna 310 and a first notch of plurality of notches 312 and 314 disposed on either edge 304 and 30. In illustrative embodiments of this disclosure, distance d 322 is approximately one centimeter. In alternate embodiments, distance d 322 should be no larger than lambda/10 or

$$\frac{λ}{10} .$$

The height and width of a pulse of the square waveform may be equal or of a uniform size. For example, in the illustrative embodiment of FIG. 3, each edge of the pulse or the height 318 and width 316 of each pulse may be approximately 5 millimeters (mm).

In an embodiment, the plurality of notches may approximate the shape of a rectangular wave where the height of a pulse of the waveform is approximately 8 mm and much less than lambda/10 or

$$\frac{λ}{10} ,$$

and the width of the pulse of the waveform is approximately 5 mm. In another embodiment, the plurality of notches may approximate the shape of a waveform that comprises a combination of square pulses and rectangular pulses.

Antenna 310 may be, but is in no way limited to, a planar inverted F antenna (PIFA), an inverted F antenna (IFA), a type of monopole antenna, and a three dimensional antenna comprised of a plurality of strip segments joined together. In an embodiment, antenna 310 may be a three-dimensional conductive U-shaped monopole structure. In another exemplary embodiment, antenna 310 may be a hex-band antenna.

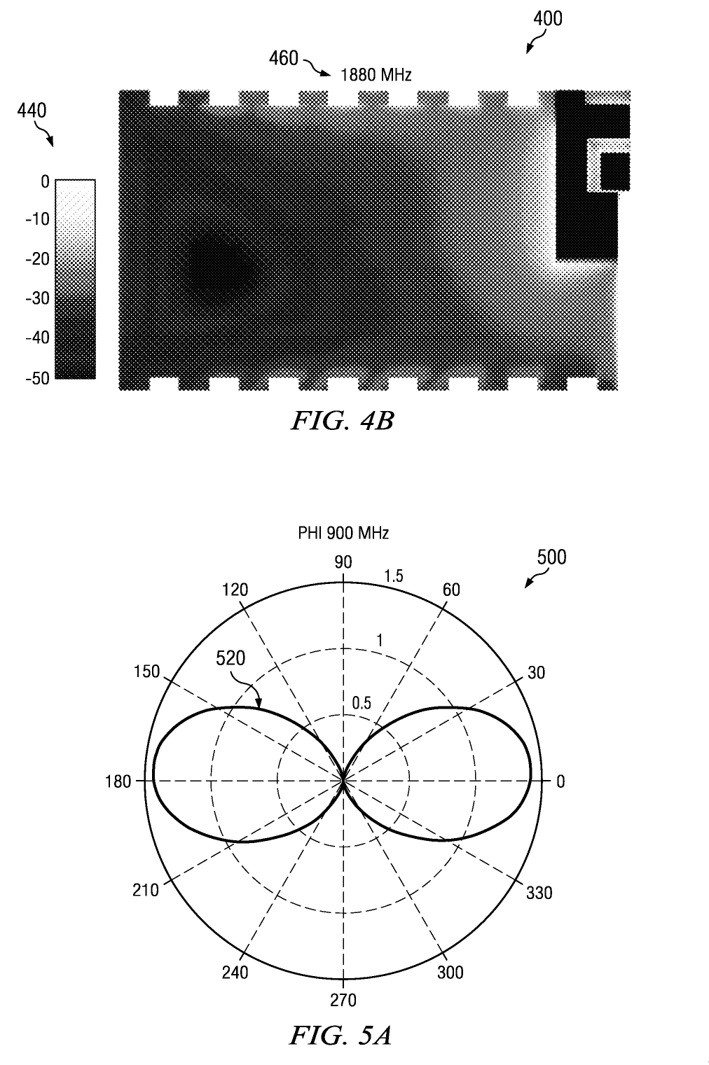

Turning now to FIG. 4A and FIG. 4B, the current distribution 400 of the notched antenna assembly 300 of FIG. 3 is illustrated at selected resonant frequencies. The notches of antenna assembly 300 are designed to produce a resonance in the ground plane at the same frequency at which the antenna resonates. The notches are used to control the electrical length of the ground plane to enable both the ground plane and the antenna to resonate at the same time. Antenna performance, such as greater efficiency and increased bandwidth, is improved when the ground plane and the antenna resonate together.

FIG. 4A illustrates current distribution 450 of the notched antenna assembly 300 illustrated in FIG. 3 at a frequency at the 900 MHz band in accordance with an illustrative embodiment of the disclosure. Scale 440 provides information in decibels (dB) on the strength of the radiation by a light to dark gradation of shading. Scale 440 starts with a light gradation at 0 dB to represent a high current intensity and radiation level and decreases significantly through 50 dB represented by a darker gradation which represents decreased current intensity and radiation.

FIG. 4A illustrates the path the current travels along the length of the ground plane at a resonant frequency at 900 MHZ band. The total distance traveled by the current in a longitudinal direction along the ground plane includes the distance the current travels along the perimeter of each notch along the edge of the ground plane.

FIG. 4B illustrates the current distribution 460 of the notched antenna assembly 300 illustrated in FIG. 3 at a frequency of 1880 MHz in accordance with an illustrative embodiment of the disclosure. Scale 440 provides information in decibels (dB) on the strength of the radiation through a light to dark gradation of shading, where lighter areas of the scale represent the greater current intensity and greater radiation. The distance from the antenna that includes the notched edges of the ground plane is greater than a linear distance from the antenna without the notches in the ground plane.

FIG. 4B illustrates the path the current travels along the length of the ground plane at the resonant frequency of 1880 MHZ. FIG. 4B illustrates that the current induced by the antenna at the resonant frequency of 1880 MHZ, travels a longer distance along the notched edges of the ground plane. The total distance traveled by the current in a longitudinal direction along the ground plane includes the distance the current travels along the perimeter of each notch along the edge of the ground plane.

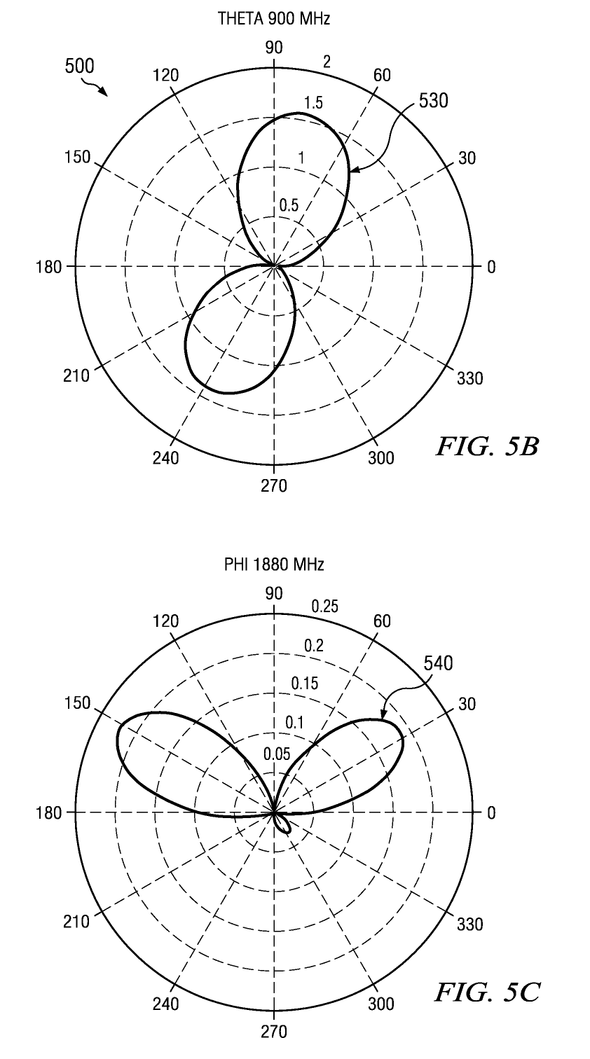

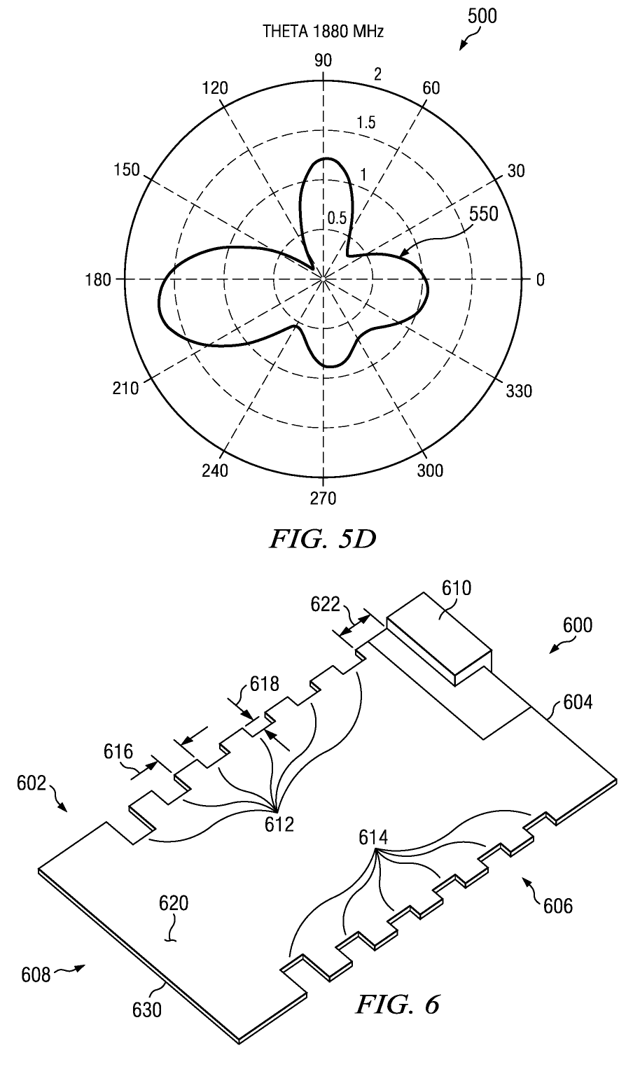

FIG. 5A through FIG. 5D illustrate two-dimensional plots 500 of the radiation pattern of notched antenna assembly 300 at frequency bands of 900 MHZ and 1880 MHz. The dimensions and number of notches do not affect the radiation characteristics of the antenna.

Referring first to FIG. 5A, two-dimensional plot 500 illustrates the radiation pattern of the notched antenna assembly 300 illustrated in FIG. 3. Polar plot 520 illustrates the far field radiation pattern in the phi plane for the notched antenna assembly with the ground plane current distribution characteristic of FIG. 4A at a frequency band at 900 MHz. In FIG. 5B, two-dimensional plot 500 illustrates a polar plot 530 of the far field radiation pattern in the theta plane for the notched antenna assembly with the ground plane current distribution characteristic illustrated in FIG. 4A for a frequency band at 900 MHz. FIG. 5C illustrates polar plot 540 in the phi plane for the notched antenna assembly illustrated in FIG. 4B for a frequency of 1880 MHz. In FIG. 5D, two-dimensional plot 500 illustrates a polar plot 550 of the far field radiation pattern in the theta plane for the notched antenna assembly illustrated in FIG. 4B at a frequency of 1880 MHZ.

In FIG. 6, antenna 610 is shown disposed on a first edge 604 of ground plane 620. Ground plane 620 has a plurality of notches 612 extending in a longitudinal direction along a second edge 602 that is opposite to and perpendicular to the plane of antenna 610 and to first edge 604. Third edge 606 has a plurality of notches 614 extending in a longitudinal direction perpendicular to the plane of antenna 610 and opposite first edge 604 and second edge 602. In illustrative embodiments, a fourth edge 608 may also include a number of notches.

Dielectric substrate 630 is disposed on an opposite side of ground plane 620 and may be configured with a pattern of a plurality of notches that is substantially the same as the pattern of plurality of notches, such as plurality of notches 612, 614, in ground plane 620. Circuit board components may be placed on ground plane 620 or on dielectric substrate 630 through the connection of signal traces to the ground plane 620.

The plurality of notches, 612 and 614, respectively, may approximate the shape of a waveform or a series of undulating waveforms with a plurality of pulses having scalloped or substantially linear edges that are uniformly disposed along each edge of the ground plane at a distance d 622 from antenna 610. Each pulse may approximate the shape of a rectangle or square. Each pulse of the waveform may be non-uniform in height and width. For example, in the illustrative embodiment of FIG. 6, the height 618 of a pulse may be 8 mm and the width 616 of each pulse may be approximately 5 millimeters (mm).

The plurality of notches 612 are used to control the electrical length of the ground plane to enable both the ground plane and the antenna to resonate at the same time. Antenna performance, such as greater efficiency and increased bandwidth, is improved when the ground plane and the antenna resonate together.

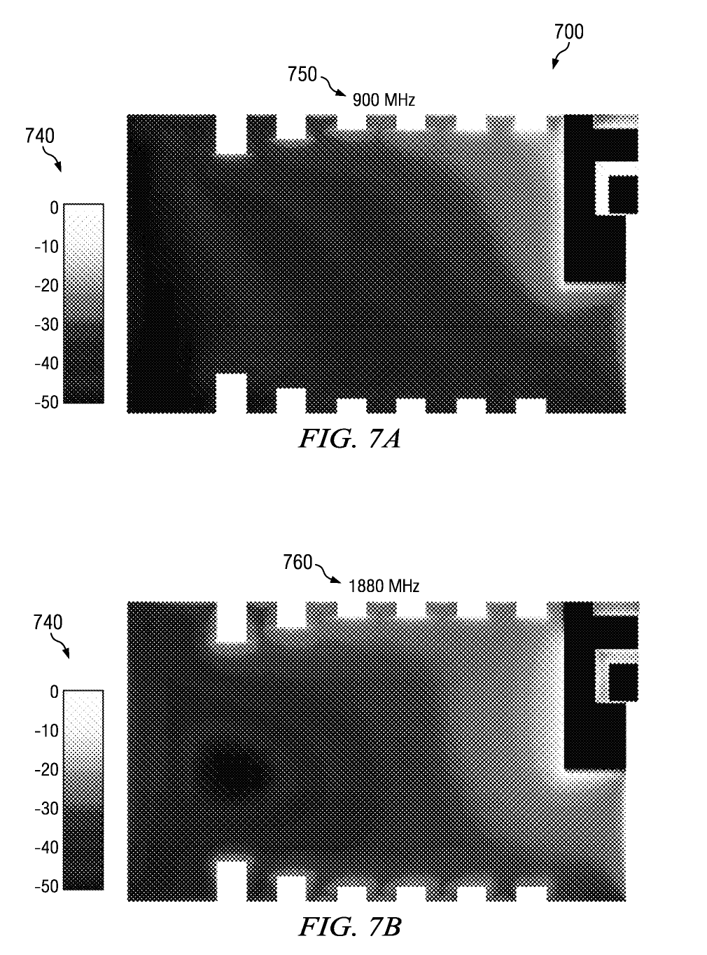

Turning now to FIG. 7A and FIG. 7B, the current distribution 700 of the notched antenna assembly 600 of FIG. 6 is illustrated at selected resonant frequencies. Scale 740 provides information in decibels (dB) on the strength of the radiation through a light to dark gradation of shading, where lighter areas of the scale represent the greater current intensity and greater radiation. The distance from the antenna that includes the notched edges of the ground plane is greater than a linear distance from the antenna without the notches in the ground plane.

FIG. 7A illustrates that the current distribution 750 induced by antenna assembly 600 at a resonant frequency band of 900 MHz travels a certain distance along each notch along the edges of the ground plane. The illustrative embodiments of FIG. 4A and FIG. 7A illustrate that the radiation characteristics of the resonating antenna assembly, 300 and 600 respectively, are not affected by the number or pattern of the notches of the ground plane. For example, antenna assembly 600 has a non-uniform pattern of notches along the edges of the ground plane. However, the current distribution 700 produced by this non-uniform pattern of notches at the resonant frequency at 900 MHz band is the same as the current distribution 400 produced by antenna assembly 300 with a uniform pattern of notches along the edges of the ground plane at the resonant frequency band of 900 MHz.

In FIG. 7B, the current distribution 760 at the resonant frequency of 1880 MHz of antenna assembly 600 of FIG. 6 is illustrated, according to an embodiment of the disclosure is illustrated. FIG. 7B illustrates that the current induced by the antenna at the resonant frequency of 1880 MHz, travels a longer distance in a longitudinal direction along the notched edges of the ground plane. The radiation pattern produced by antenna assembly 600 at 1880 MHz is not affected by the number or pattern of the notches in the ground plane.

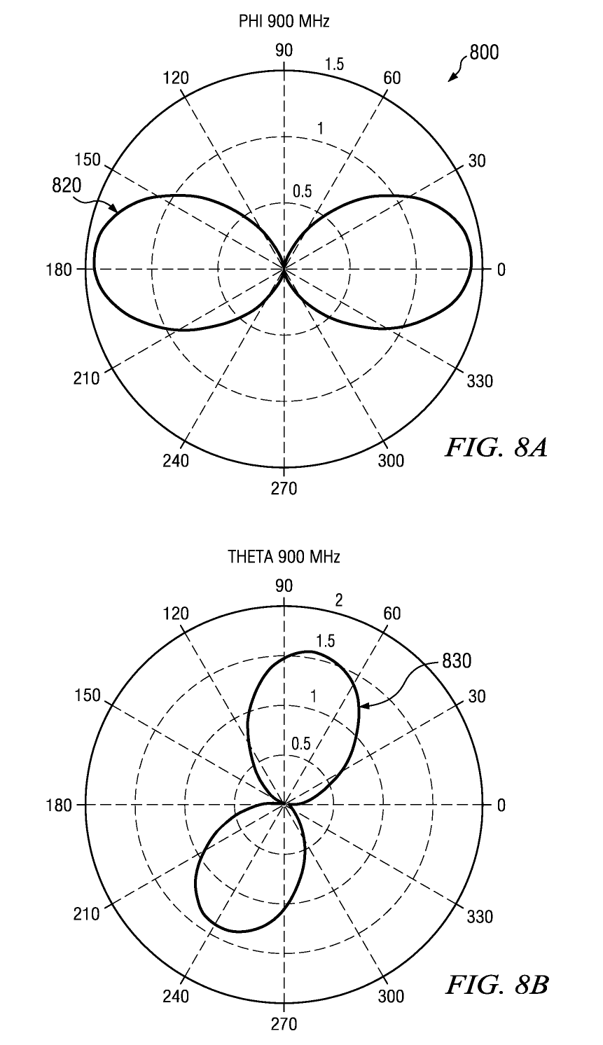

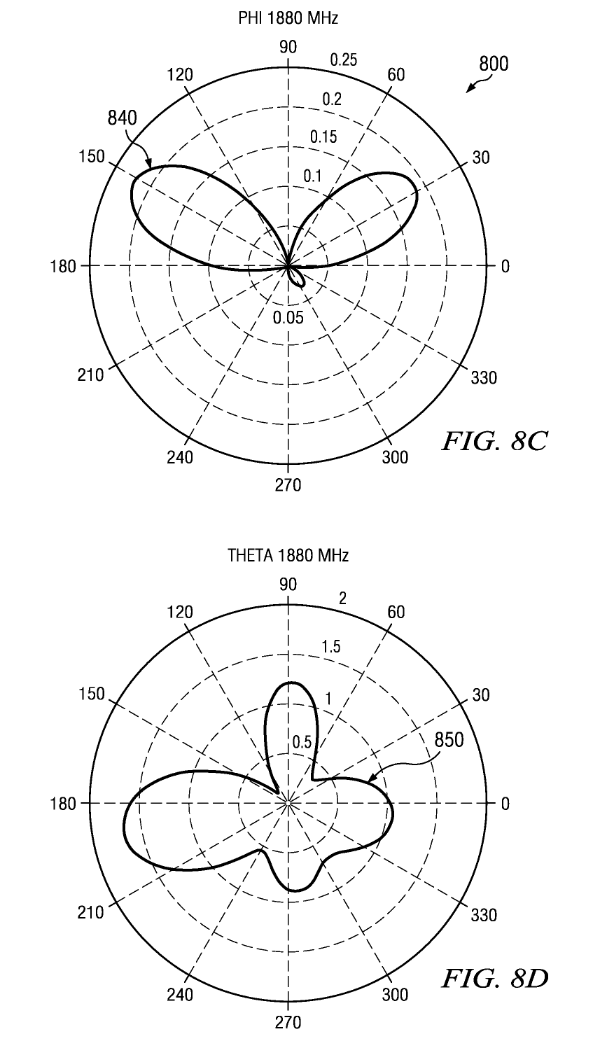

FIG. 8A through FIG. 8D illustrate two-dimensional plots 800 of the antenna radiation pattern at frequency bands of 900 MHZ and 1800 MHz. The far field radiation patterns for antenna assembly 600 illustrated by FIG. 8A through FIG. 8D are similar to the far field radiation patterns generated by antenna assembly 300 as illustrated by FIG. 5A through FIG. 5D. The similarity of the far field radiation patterns in FIG. 8A through FIG. 8D and FIG. 5A through FIG. 5D illustrates that the number and size of the notches in an antenna assembly, such as in the illustrative examples of antenna assembly 300 and antenna assembly 600, have no effect on the radiation characteristics of each respective antenna.

FIG. 8A illustrates polar plot 820 that depicts the far field radiation pattern of antenna assembly 600 with the ground plane current distribution characteristic of FIG. 7A in the phi plane at a frequency band of 900 MHz. Polar plot 820 has approximately the same radiation pattern illustrated by polar plot 520 for notched antenna assembly 300.

FIG. 8B illustrates polar plot 830 in the theta plane for notched antenna assembly 600 of FIG. 6. Polar plot 830 depicts the far field radiation pattern of antenna 610 with the ground plane current distribution characteristic of FIG. 7A in the theta plane at a frequency of 900 MHz. Polar plot 830 has approximately the same radiation pattern illustrated by plot 530 for notched antenna assembly 300.

FIG. 8C illustrates polar plot 840 in the phi plane at a frequency of 1880 MHz for notched antenna assembly 600 of FIG. 6. Polar plot 840 depicts the far field radiation pattern of antenna 610 with the ground plane current distribution characteristic of FIG. 7B. Polar plot 840 has approximately the same radiation pattern illustrated by polar plot 540 of FIG. 5C for notched antenna assembly 300.

FIG. 8D illustrates polar plot 850 in the theta plane for notched antenna assembly 600 of FIG. 6. Polar plot 850 depicts the far field radiation pattern of antenna assembly 600 with the ground plane current distribution characteristic of FIG. 7B in the theta plane at a frequency of 1880 MHz. Polar plot 850 has approximately the same radiation pattern illustrated by plot 550 of FIG. 5D for notched antenna assembly 300.

In illustrative embodiments of this disclosure, the radiation efficiency of the notched antenna assembly is increased over an antenna assembly that is not notched. For example, in low frequency bands below one Gigahertz, 1 GHz, such as, without limitation, 900 MHz, notched antenna assembly 300 and notched antenna assembly 600 provides at least a 3% increase in efficiency over an antenna assembly that does not include notches. In high frequency bands above 1 GHz, such as, without limitation, 1880 MHz or 1.9 GHz, the efficiency either remains unchanged or increases over an antenna assembly that does not include notches. In the high frequency bands, there is no degradation or reduction of performance.

Similarly, the effective bandwidth of a notched antenna assembly increases over that of an antenna assembly that is not notched. For example, in low frequency bands below one 1 GHz, such as, without limitation, 900 MHz, notched antenna assembly 300 and notched antenna assembly 600 may provide up to a 22% increase in bandwidth over an antenna assembly that does not include notches. In high frequency bands above 1 GHz, such as, without limitation, 1880 MHz or 1.9 GHz, there is a positive percentage change in bandwidth over an antenna assembly that does not include notches.

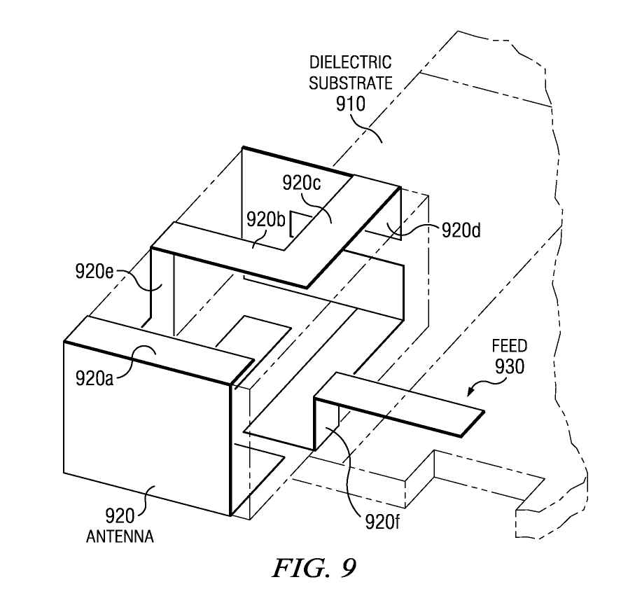

FIG. 9 illustrates an antenna of the notched antenna assembly in accordance with an illustrative embodiment of the disclosure. Antenna 920 may be antenna 106 of notched antenna assembly 104 illustrated in FIG. 1.

Antenna 920 may comprise individual electrically conductive strip segments, such as, without limitation, strip segment 920a, 920b, 920c, 920d, and 920e, connected together on a dielectric substrate 910. Dielectric substrate 910 may be a polyhedron that is rectangular in shape and have a plurality of surfaces. Antenna 920 includes a signal feed 930 that connects directly to one or more conductive strip segments, such as strip segment 920f.

The strip segments may be connected to surfaces of dielectric substrate 910 by soldering, etching, or some other connective or adhesive means known to one skilled in the art. The strip segments may be formed from copper or some other conductive material known to one skilled in the art. Dielectric substrate 910 may be formed from a material that includes, but is in no way limited to, air, fiberglass, plastic, and ceramic. In an embodiment, dielectric substrate 910 may be formed from an FR-4 laminate that is a continuous glass-woven fabric reinforced with an epoxy resin binder.

In illustrative embodiments of the disclosure, antenna 920 may be configured for operation in multiple frequency bands. For example, without limitation, antenna 920 may operate as a hex-band antenna that resonates in a plurality of different operating frequency bands including, but in no way limited to, the Global System for Mobile communications (GSM) 900 MHz frequency band, the Digital Cellular System (DCS) frequency band, and the Universal Mobile Telecommunications System (UMTS) 2100 MHz band.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein.

The embodiment or embodiments selected are chosen and described in order to best explain the principles of the embodiments, the practical application, and to enable others of ordinary skill in the art to understand the disclosure for various embodiments with various modifications as are suited to the particular use contemplated. For example, the various elements or components may be combined or integrated in another system or certain features may be omitted or not implemented.

Also, techniques, systems, and subsystems, and described and illustrated in the various embodiments as discrete or separate may be combined or integrated with other systems, modules, or techniques without departing from the scope of the present disclosure. Other items shown or discussed as coupled or directly coupled or communicating with each other may be indirectly coupled or communicated through some other interface, device or intermediate component whether electrically, mechanically, or otherwise. Other examples of changes, substitutions, and alterations are ascertainable by one skilled in the art and could be made without departing from the spirit and scope disclosed herein.

What is claimed is:

1. An antenna assembly for a wireless communications device, comprising:
a single ground plane having a plurality of notches spaced apart at a distance from each other along at least two opposing longitudinal edges of said single ground plane, wherein each notch of said plurality of notches is dimensioned to eliminate radiation from the individual notches; and
a single antenna disposed at an edge of said ground plane that is perpendicular to a first opposing longitudinal edge and a second opposing longitudinal edge of said at least two opposing edges,
wherein said plurality of notches are positioned at a distance that prevents radiative coupling with said single antenna.

2. The antenna assembly of claim 1, further comprising:
a plurality of components disposed on said surface of said single ground plane.

3. The antenna assembly of claim 1, wherein said single ground plane and said single antenna resonate at the same frequency.

4. The antenna assembly of claim 1, wherein each notch of said plurality of notches of said single ground plane has an edge that is sized to a length of less than λ/10.

5. The antenna assembly of claim 1, wherein said single antenna comprises a plurality of radiating strips folded onto a three-dimensional substrate.

6. The antenna assembly of claim 1, wherein said single antenna connects to said ground plane on a first side of said single ground plane through a feed point.

7. The antenna assembly of claim 1, wherein said single ground comprises a plurality of notches that are spaced apart at a non-uniform distance from each other.

8. The antenna assembly of claim 1, wherein said single ground plane comprises a plurality of notches that are spaced apart at a uniform distance from each other.

9. The antenna assembly of claim 1, further comprising a dielectric substrate coupled to a second side of said single ground plane, wherein said dielectric substrate is configured to form the same shape as said ground plane.

10. The antenna assembly of claim 1, wherein said plurality of notches of single ground plane are selected from the group consisting of square notches and rectangular notches.

11. The antenna assembly of claim 1, wherein the antenna is a hex-band antenna.

12. The antenna assembly of claim 1, wherein said single antenna comprises a plurality of conductive strip segments folded onto a three-dimensional substrate.

13. A mobile wireless communications device, comprising:
a single ground plane having a plurality of notches spaced apart at a distance from each other and disposed along at least two opposing edges of said ground plane, wherein said plurality of notches are individually non-radiating; and
a single antenna disposed at an edge of said single ground plane that is perpendicular to a first opposing longitudinal edge and a second opposing longitudinal edge of said at least two opposing edges, said single antenna being positioned at a distance that prevents radiative coupling with said plurality of notches,
wherein said single antenna induces current on said single ground plane.

14. The mobile wireless communications device of claim 13, wherein said single ground plane has a surface that is populated by a number of components.

15. The mobile wireless communications device of claim 13, wherein each notch of said plurality of notches has an edge that is sized to a length of less than λ/10.

16. The mobile wireless communications device of claim 13, wherein said single antenna is a hex-band antenna.

17. The mobile wireless communications device of claim 13, wherein said single antenna comprises a plurality of radiating strips folded onto a three-dimensional substrate.
